(19) United States
(12) Patent Application Publication
(10) Pub. No.: US 2026/0197605 A1
(43) Pub. Date: Jul. 9, 2026

(54) Hybrid Network System with AI-Based Core Management, Dynamic Localization, and Energy-Efficient Modular Architecture

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/012,650

(22) Filed: Jan. 7, 2025

(51) Int. Cl. H04W 4/029; H04W 52/02

(52) U.S. Cl. CPC H04W 4/029; H04W 52/0229

(57) ABSTRACT

This hybrid network system integrates a modular architecture that supports multi-protocol adaptability, enabling seamless wired and wireless communication with optional Power Line Communication (PLC). The system features AI-driven management for dynamic routing, resource allocation, and application-level analytics. It incorporates advanced localization techniques, including Received Signal Strength Indicator (RSSI), Angle of Arrival (AoA), Time of Flight (ToF), and Channel Sounding, to provide precise positioning. Additionally, the system operates in offline and online modes, ensuring continuous functionality during intermittent connectivity. Energy-efficient protocols further enhance its performance, making the system robust and scalable for a wide range of applications, including industrial automation, precision agriculture, and military operations. The comprehensive integration of these technologies provides a unified solution for efficient and reliable network management and data processing.

### CROSS-REFERENCE TO RELATED APPLICATIONS

### U.S. Patent Documents

U.S. Pat. No. 6,549,937 B1 April 2003 Auerbach et al.
U.S. Pat. No. 11,075,802 B2 July 2021 Hardison et al.
U.S. Pat. No. 10,742,778 B2 August 2020 Huo et al.
U.S. Pat. No. 7,042,351 B2 May 2006 Kline et al.
20220036202 A1 February 2022 Sivashanmugam et al.
U.S. Pat. No. 10,209,081 B2 February 2019 Ghadiok et al.
20160234342 A1 August 2016 OOnk et al.
U.S. Pat. No. 9,860,677 B1 January 2018 Agerstam et al.

### Other Publication

Wang, X et al, “Artificial Intelligence-Based Techniques for Emerging Heterogeneous Network: State of the Arts, Opportunities, and Challenges” in IEEE Access, vol. 3, pp. 1379-1391, 2015, doi: 10.1109/ACCESS.2015.2467174.
WO 2019200153 A1 October 2019 Mostofi et al.
WO 2021207179 A1 October 2021 Choi et al.
CN 116027741 A April 2023 Yuan et al.
Sung, J et al. “Hybrid Powerline/Wireless Diversity for Smart Grid Communications: Design Challenges and Real-time Implementation”, eess.SP, 14 Aug. 2018, https://arxiv.org/pdf/1808.04530

### BACKGROUND OF THE INVENTION

The present invention relates to hybrid networking systems, integrating multi-protocol communication, AI-based core management, dynamic localization methods, and energy-efficient protocols within a modular architecture. It addresses the needs of industries such as agriculture, manufacturing, military, and smart infrastructure, offering features for offline and online AI operation and scalability.

### SUMMARY OF THE INVENTION

The present invention provides a hybrid networking system with a modular architecture. A main server is responsible for centralized management and integration of sub-servers, which may include devices such as Pi 5 with nRF52840 modules, enabling distributed control and localized processing. Device nodes are equipped with PWM outputs, RS485, I2C, and analog inputs/outputs (4-20 mA, 0-10V).

The system supports dynamic localization, utilizing technologies such as RSSI (Received Signal Strength Indicator), Angle of Arrival (AoA), Time of Flight (ToF), and Channel Sounding for precise positioning. An AI module combines and refines these localization data to ensure accuracy and reliability.

AI-based core management is integral to the system, handling network-level tasks such as dynamic routing, self-healing, and resource allocation. Additionally, it provides application-level analytics including predictive maintenance and user analytics.

The system operates autonomously in offline mode using local AI inference and databases, maintaining critical operations during network outages. In online mode, the system synchronizes data with cloud servers, facilitating global analytics and model updates.

Energy optimization is a key feature, with protocols for wake-up and sleep cycles to conserve power and adaptive resource allocation for efficient energy use.

The system supports multiple communication protocols including WiFi, Bluetooth, Bluetooth Mesh, Thread, Modbus, MQTT, CoAP, and optionally Power Line Communication (PLC). High-level interfaces allow customization for specific applications, accommodating various protocols such as MQTT and Modbus.

### BRIEF DESCRIPTION OF DRAWINGS

FIG. 1: System Architecture Overview: Illustrates the modular architecture of the hybrid network system, detailing the connections and roles of main servers, sub-servers, and device nodes.

FIG. 2: Offline/Online AI Operation: Demonstrates the interaction between the local server (operating offline) and the cloud server (operating online), highlighting the seamless AI operations across both environments.

FIG. 3: Dynamic Localization Flow: Shows the integration of RSSI (Received Signal Strength Indicator), AoA (Angle of Arrival), ToF (Time of Flight), and Channel Sounding data into the AI fusion module, depicting the dynamic localization process.

FIG. 4: Core AI Integration: Highlights the functionality of the AI-based manager, showcasing how it handles both network-level and application-level tasks, ensuring efficient management and operation.

FIG. 5: Energy Optimization Protocols: Describes the energy optimization protocols, including the wake-up/sleep cycles and resource allocation strategies, designed to enhance energy efficiency within the modular architecture.

### DETAILED DESCRIPTION OF THE INVENTION

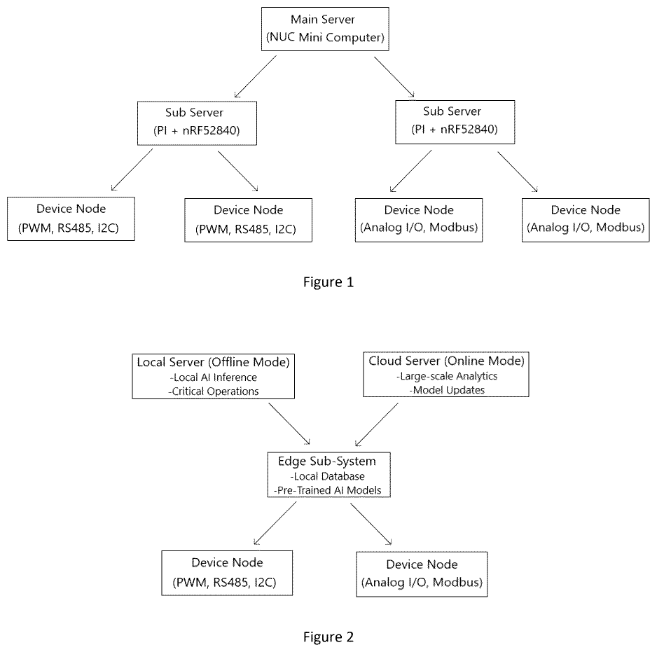

FIG. 1 illustrates the system block diagram of the hybrid network system. At the center of this setup is the main server, potentially a NUC Mini Computer, responsible for managing sub-servers and device nodes. These sub-servers, such as the Pi 5 with nRF52840, function as Thread border routers, providing localized processing and dynamic positioning. The device nodes are equipped with PWM outputs for precise control, RS485 and I2C interfaces for industrial integration, and analog inputs/outputs (4-20 mA, 0-10V) for environmental monitoring.

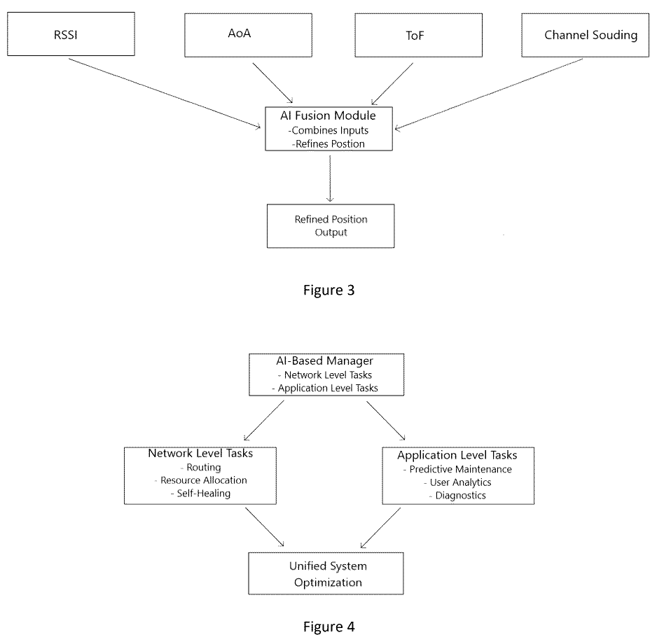

FIG. 3 depicts the localization subsystem. This subsystem integrates multiple technologies, including RSSI (Received Signal Strength Indicator), AoA (Angle of Arrival), ToF (Time of Flight), and Channel Sounding to achieve precise positioning. An advanced AI fusion module refines these inputs, ensuring high accuracy and reliability in location data.

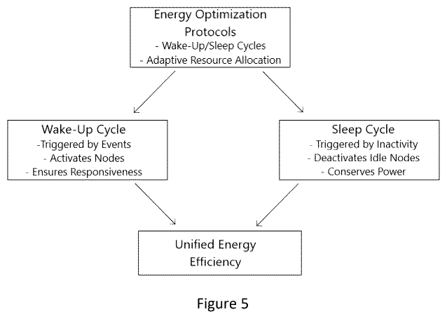

FIG. 4 demonstrates the core management powered by AI. The AI-based manager performs an array of network-level tasks, including dynamic routing, self-healing mechanisms, and efficient resource allocation. Additionally, it provides application-level analytics, offering predictive maintenance, real-time diagnostics, and insightful user analytics.

FIG. 2 illustrates the system's dual-mode operation. In offline mode, local servers maintain critical operations during network outages, utilizing local databases and AI inference models. In online mode, the system synchronizes logs, analytics, and AI models with cloud servers, ensuring continuous operation and global analytics.

FIG. 5 shows the detailed energy optimization protocols of the system. This architecture optimizes energy consumption through event-triggered wake-up cycles and inactivity-triggered sleep cycles, enhancing overall energy efficiency and sustainability.

1. A hybrid network system, comprising:
A main server managing sub-servers and device nodes;
One or more wireless links (e.g., WiFi, Thread Network) and optional wired links, wherein a wired link may include Power Line Communication (PLC);
An AI-based manager for both network-level and application-level tasks;
A localization subsystem using RSSI, AoA, ToF, and Channel Sounding;
Offline/online modes for continuous operation with or without cloud connectivity.

2. The system of claim 1, wherein the main server integrates features from sub-servers and provides a unified interface for MQTT, CoAP, Modbus, and application-specific protocols.

3. The system of claim 1, wherein device nodes support PWM outputs, RS485, I2C, and analog I/O.

4. The system of claim 1, wherein the localization subsystem fuses multiple signals for refined positioning.

5. The system of claim 1, further comprising energy-saving protocols for wake-up and sleep cycles.

6. A method for operating a hybrid network system, comprising:
Establishing a modular architecture with a main server and sub-servers;
Integrating a localization subsystem using RSSI, AoA, ToF, and Channel Sounding;
Managing network-level tasks and application analytics using an AI-based manager;
Operating in offline mode using local databases and AI inference models;
Synchronizing logs and analytics upon transitioning to online mode.
